(19) United States
(12) Patent Application Publication
(10) Pub. No.: US 2010/0072640 A1
(43) Pub. Date: Mar. 25, 2010

(54) MANUFACTURING A REPLICATION TOOL, SUB-MASTER OR REPLICA

(75) Inventors: Hartmut Rudmann, Unterlunkhofen (CH); Susanne Westenhofer, Wettswil (CH); Stephan Heimgartner, Luzern (CH); Markus Rossi, Jona (CH)

Correspondence Address: RANKIN, HILL & CLARK LLP, 38210 Glenn Avenue, WILLOUGHBY, OH, 44094-7808, US

(73) Assignee: HEPTAGON OY, Espoo (FI)

(21) Appl. No.: 11/423,344

(22) Filed: Jun. 9, 2006

(51) Int. Cl. B29D 11/00

(52) U.S. Cl. 264/2.5

(57) ABSTRACT

In a process of manufacturing, by replication, a plurality of optical elements each having geometrical surface features, a method of manufacturing an element that includes a plurality of replicated structures is provided. The method comprises the steps of providing an element substrate, of replicating, by embossing, a surface of a tool element, which surface comprises a negative copy of the geometrical surface feature, into replication material disposed at a first place on a surface of the element substrate, of subsequently hardening the replication material, of replicating said surface of the tool element into replication material disposed at a second place on said substrate, of hardening said replication material, the method comprising the further step of subsequently filling a gap between replication material disposed at the first place and replication material disposed at the second place by filler material.

### BACKGROUND OF THE INVENTION

1. Field of the Invention

The invention is in the field of manufacturing, by replication, optical elements, in particular refractive optical elements or diffractive micro-optical elements. More concretely, it deals with a method of replicating an element and a process of manufacturing a plurality of optical elements.

2. Description of Related Art

Fabrication of optical elements by replication techniques, such as embossing or molding, is known. Of special interest are the wafer-scale fabrication processes, where an array of optical elements is fabricated on a disk-like (“wafer-”) structure, which, subsequent to replication, is separated (“diced”) into the individual elements.

Replication techniques include injection molding, roller hot embossing, flat-bed hot embossing, and UV embossing. As an example, in the UV embossing process, the surface topology of a master structure is duplicated into a thin film of a UV-curable replication material such as an UV curable epoxy resin on top of a substrate. The replicated surface topology can be a refractive or a diffractive optically effective structure, or a combination of both. For replicating, a tool (negative copy) is prepared from a master, which is then used to UV-emboss the epoxy resin. The master can be a lithographically fabricated structure in fused silica or silicon, a laser or e-beam written structure, a diamond turned structure or any other type of structure.

To achieve a cost effective mass production of replicated micro-optical components, a wafer-scale replication process is desirable. A ‘wafer’ in the meaning used in this text is a disc or a rectangular plate of any dimensionally stable, often transparent material. The diameter of the disk is typically between 5 cm and 40 cm, for example between 10 cm and 31 cm. Often it is cylindrical with a diameter of either 2, 4, 6, 8 or 12 inches, one inch being about 2.54 cm. The wafer thickness is for example between 0.2 mm and 10 mm, typically between 0.4 mm and 6 mm. The wafer-scale replication allows the fabrication of several hundreds of identical structures with a single step, e.g. a single or double-sided UV-embossing process. The subsequent separating (‘dicing’) step of the wafer then yields the individual micro-optical components.

For an efficient wafer-scale replication technology, a wafer-scale tool (negative copy of the replica to be manufactured) is required for fabricating the replica. Since such a waver-scale tool can only be used for a limited number of replication processes and since, therefore, a substantial number of wafer-scale replication tools are needed, it is also advantageous to have a wafer-scale sub-master (positive copy of the final replica to be manufactured), from which the replication tool may be cast or otherwise replicated. However, in many cases it is either not possible or very costly to directly produce a master or master tool that covers a sufficiently large area (typically at least 4-6 inches, up to 8 or 10 or 12 inches). For instance, mastering techniques such as e-beam writing or diamond turning typically cover only a small area in the range of several square mm which is only the size of an individual micro-optical component. Therefore, a process is required that closes the gap between the size of the individual component to the full wafer scale.

In WO 2005/057283, it has been proposed to manufacture a replication tool, sub-master or replica by means of a so-called recombination process. Recombination is the repeated replication of a single, small-scale structure over a large area, typically by embossing into a thermoplastic or thermosetting replication material. An embodiment of the recombination process disclosed in WO 2005/057283 relies on a so-called recombination framework, i.e., a framework of troughs into which the small-scale structure (master, sub-master or master tool) is replicated. This method features the substantial advantage that the position of the replicated structures with respect to all spatial dimensions is defined by the recombination framework. However, there are situations where a recombination framework is either not feasible, too laborious, or not suitable for the structure to be produced by the replication process.

### BRIEF SUMMARY OF THE INVENTION

It is therefore an object of the invention to provide an alternative method of fabricating an element to be used in a process of manufacturing, by replication, an optical element. The element includes a plurality of structures replicated from a prototype, and should allow for control, at least, of the thickness dimension (the z-coordinate) of the final replica.

Therefore, in a process of manufacturing, by replication, a plurality of optical elements each having geometrical surface features, a method of manufacturing an element that includes a plurality of replicated structures is provided. The method comprises the steps of providing an element substrate, of replicating, by embossing, a surface of a tool element, which surface comprises a negative copy of the geometrical surface feature, into replication material disposed at a first place on a surface of the element substrate, of subsequently hardening the replication material, of replicating the surface of the tool element into replication material disposed at a second place on the substrate, of hardening the replication material. The method further includes the step of subsequently filling a gap between replication material disposed at the first place and replication material disposed at the second place by filler material.

The element, including a plurality of replicated structures, may be a ‘sub-master’, i.e. an element that comprises surface portions corresponding to a positive copy of a surface portion of the optical element to be replicated. The tool element may be a so-called ‘master tool’, i.e. an element that comprises a surface portion corresponding to a negative copy of a surface portion of the optical element to be replicated.

The replication material may be disposed step by step, i.e. at the second place it is disposed after the replication material at the first place is hardened. According to a less preferred variant, the replication material may also be disposed at a plurality of places at once. Then, the hardening step has to be carried out position selectively, for example, by means of an appropriate mask where the hardening step includes curing a thermosetting replication material by means of illumination by electromagnetic or other radiation, such as UV radiation.

For the sake of convenience, the dimension perpendicular to the surface of the substrate, which comprises an essentially flat surface—is denoted as “height”. In actual practice, the entire arrangement may also be used in an upside down configuration or also in a configuration where the substrate surface is vertical or at an angle to the horizontal. The direction perpendicular to the surface is denoted z-direction. The terms “periphery”, “lateral” and “sides” relate to a direction perpendicular to the z-direction.

The added filling material makes complete control of the z-dimension of the crucial surface portions of the final replica possible, even if its own thickness is not precisely controlled at all. This is because, due to it, the minimal thickness of the element produced may be at sections where the substrate is covered by the replication material and where the z-dimension relative to the replication section (the portion that will finally account for the desired optical properties of the optical element produced) has been defined by the replication. Such sections of minimal thickness correspond to protruding portions (spacer portions) of the tool replicated in a further replication step. They may be used to precisely define the thickness of the optical element.

In other words, this definition of the z dimension becomes possible since the structure of the tool that protrudes the most is next to the optical structures and is defined already in the single master or master tool.

In accordance with an other aspect of the invention, a process of manufacturing a plurality of optical elements each having surface features is provided, the process comprising the steps of providing a master or a master tool and carrying out at least a first and a second replication operation to replicate a surface portion of the master or master tool to provide a final replica, the first replication operation comprising a method of manufacturing an element including the steps of
providing an element substrate,
replicating, by embossing, a surface of a tool element, which surface comprises a negative copy of the geometrical surface feature, into replication material disposed at a first place on a surface of the element substrate,
subsequently hardening the replication material,
replicating the surface of the tool element into replication material disposed at a second place on the substrate,
hardening the replication material,
subsequently filling a gap between replication material disposed at the first place and replication material disposed at the second place by filler material,
   the second replication operation including the step of providing a substrate, and a second replication material disposed between the substrate and the element, of moving the substrate and the element against each other, and of hardening the second replication material.

The element may be a sub-master. The second replication material may be of the same or of a different composition than the first replication material.

### BRIEF DESCRIPTION OF THE DRAWINGS

In the following, preferred embodiments of the invention are described referring to schematic drawings. None of the drawings is to scale. In the drawings:

FIG. 1 schematically shows a generation process with a recombination step;

FIG. 2 shows, in section, a replication tool;

FIG. 3 shows a view of a sub-master during its manufacture;

FIG. 4 shows, in section, a sub-master during its manufacture; and

FIG. 5 shows a flowchart of an embodiment of the method according to the invention.

### DESCRIPTION OF THE PREFERRED EMBODIMENTS

In this text, ‘replication’ is used for a process of ‘casting’ in a broad sense, i.e. of making a ‘negative’ copy of a structured portion of the element to be replicated. When the resulting element is again replicated, this leads to a ‘positive’ copy of the initially replicated element. In this text, elements that comprise surface parts being a negative copy of portions of the final optical element to be manufactured are called ‘tools’, for example ‘replication tool’ or ‘master tool’. Elements including surface portions with a positive copy of the final element to be manufactured are called ‘master’, ‘sub-master’, or, for the final copy to be diced into the optical elements, ‘final replica’ or ‘replica’.

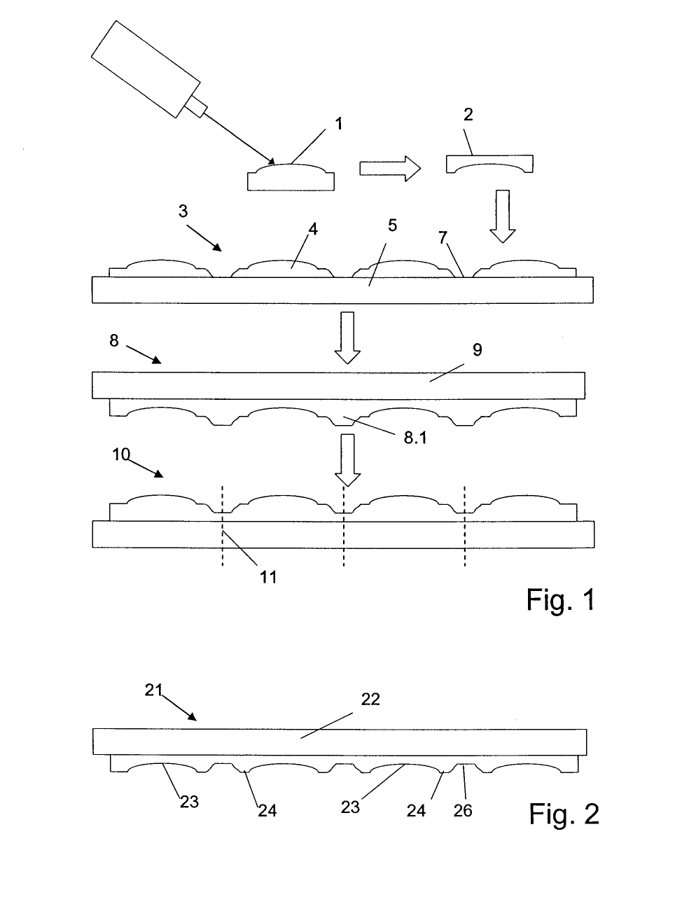

FIG. 1 very schematically shows steps in a generation process for fabricating a plurality of optical elements by wafer-scale replication. In a first step, a master 1 is produced by any suitable method, such as diamond turning or another method. In the figure, a laser beam writing process is symbolized. In the embodiment shown, the master 1 is replicated to yield a first generation tool 2 or master tool. In a recombination process at least one (second generation) sub-master 3 is manufactured. The sub-master in the shown embodiment is the result of a recombination operation and includes a plurality of portions 4 of replication material disposed at different places on a substrate 5, and each comprising an identical replicated structure being a negative copy of the master tool structure. From each sub-master, 2^{nd} generation replication tools 8 are produced which may be used for manufacturing the final replicas 10 (wafer with the micro-optical or micro-mechanical elements to be diced; dicing lines 11) or may be used for manufacturing next generation sub-masters.

In every one of the above steps, not only one element, but a plurality of elements may optionally be generated by replication. Thus, corresponding to an initial master, tens of master tools, hundreds of sub-masters, and thousands of replication tools may be manufactured.

In a production process it is also possible to initially fabricate, by a mastering operation, such as laser beam writing or diamond turning, a master tool, i.e. a negative copy instead of a positive copy of the element to be finally replicated. Also as an alternative, the recombination step can also be applied in any generation, depending on the needs to preserve and protect the original structure. For example, the sub-masters or even the 2^{nd} generation replication tools may be small-dimension parts and comprise the structure to be replicated only once, so that the recombination process is used for producing the sub-master or the 2^{nd} generation replication tools, or the replica, respectively. In other words, the recombination may be applied in the 1^{st}, 2^{nd} or 3^{rd} generation etc. Also, a scale-up generation process may be envisaged, where recombination processes may be used in more than one stage, for example by using a small size master, a medium size 1^{st} generation replication tool, and ‘large’ size sub-masters or similar.

As to the replication material, in any one of the steps, any suitable material which can be brought from a liquid or viscous or plastically deformable state into a state where it is dimensionally stable can be used. As an example, the replication material may be an epoxy, such as a UV curable epoxy. As a second example, the replication material may be PDMS. The replication material may but need not be identical for the different replication steps. Except for the final replication (depending on the nature of the optical element replicated), the replication material need not be transparent.

The replication process may be an embossing process or another cast process. An example of such another cast process is described in WO 2004/068198 with reference to FIGS. 14-16.

In the embodiment of the generation process described with respect to FIG. 1, there remain gaps 7 between the portions 4 of replication material. If in the subsequent replication step the replication material is dispersed on the substrate 9, these gaps produce protrusions 8.1 in the negative copy. These protrusions 8.1, the height of which is not defined by the mastering process, but is only defined to the extent that the distance between the master tool 2 and the substrate 5 in the replication steps of the recombination process is defined. This may be disadvantageous if spacer portions are used.

An example of a replication tool 21 for wafer-scale replication (as corresponding to the last step in the above-described generation process), which replication tool comprises spacer portions is shown in section in FIG. 2.

The replication tool 21 comprises a plurality of replication sections 23, i.e. negative structural features defining the shape of elements to be created with the tool. In the figure, a simple shape for a refractive optical element is shown, however, it is also possible to provide more sophisticated structures for refractive and/or diffractive optical elements. The replication tool further comprises spacer portions 24. The spacer portions 24 may at least partially surround the replication sections 23. The replication tool further comprises spill zones 26 for excess replication material. In the shown embodiment, the spill zones are located around the dicing lines, i.e. the lines where after replication, hardening and removing the replication tool the substrate with hardened replication material is separated into individual parts, finally to be separated into the individual optical components. This need not be the case. Rather, spacer portions may cover the dicing lines, as has been described in the U.S. patent application Ser. No. 11/384,558 incorporated herein by reference.

At least some of the spacer portions may, during replication, abut the substrate. In addition or as an alternative, at least some of the spacer portions may be ‘floating’, i.e. a thin base layer of replication material may remain between the spacer portions and the substrate during final replication. The purpose of the spacer portions is one or a combination of the following:
The spacer portions precisely determine a reference height of the replicated structures above the substrate.
The spacer portions may absorb at least part of the force between the tool and substrate during replication.
The spacer portions also allow the tool to adapt to irregularities of the planarity of the substrate.
Spacer portions arranged along the dicing lines help to prevent delaminating of the replication material from the substrate.

The replication tool 21 further comprises a rigid back plate 22 to make it dimensionally stiff on a large scale.

As an alternative to the shown embodiment, the replication tool may be designed in accordance with the teaching of the international application publication WO 2004/068 198 and/or of any one of the U.S. application Ser. Nos: 11/384,562, 11/384,537, 11/384,563, and 11/384,558, which are assigned to the same company as the present application, and which are all incorporated herein by reference.

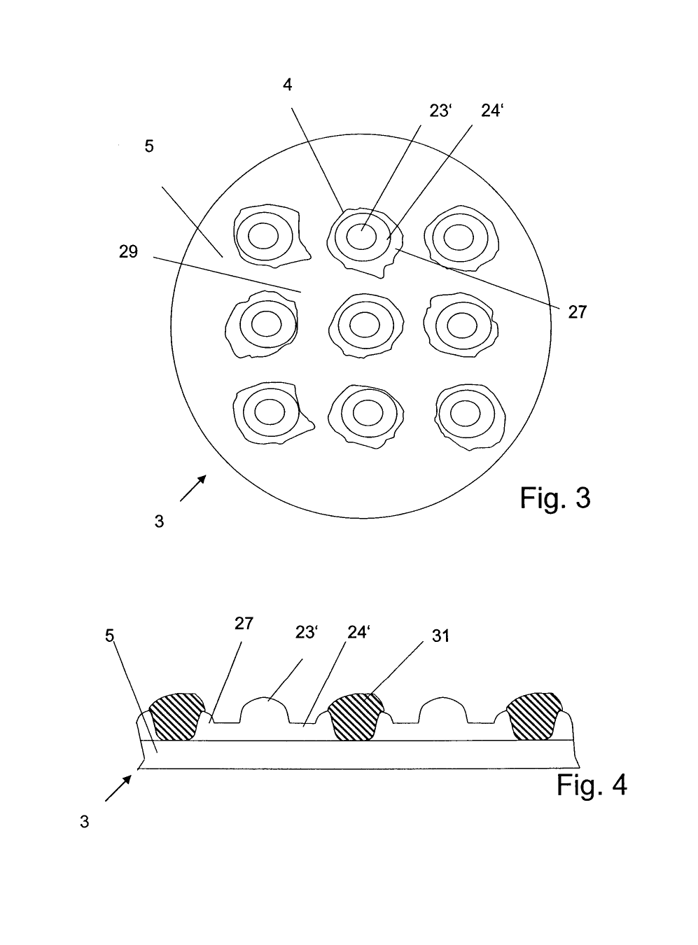

FIG. 3 shows a very schematic example of a disk-shaped substrate 5 of a sub-master 3, after recombination. On the substrate, a plurality of replication material portions 4 are shown, each comprising the inverse of a replication section 23′ and of a spacer portion 24′ surrounding it. The remaining material 27 around the spacer portion has an undefined shape and height. Between the replication material portions 4, a gap 29 remains, where the substrate is not covered by replication material. In accordance with the invention, at least one gap is now filled before the sub-master is used in the next replication step to cast a tool from it.

The substrate 5, also called ‘element substrate’ in this text, for example has the approximate size and shape of an optical wafer, which later is used for the final replica. However, in contrast to the optical wafer, the element substrate 5 need not necessarily be transparent.

The filling of the gap is illustrated in FIG. 4. The filler material 31 fills the entire space between the replication material portions. Its height is greater than the minimal height of the replication material portions at the place of the spacer portion 24′.

In accordance with a first embodiment, the gap is filled by a plastic material, such as an epoxy. It may be filled by material of the same composition as the replication material.

According to a second embodiment, the gap may be filled by material of a primarily metallic composition. Especially, the substrate 5 may be metallic or comprise a metallic surface, and the material may be added galvanically, i.e. by electroplating. For example, the filling may be made of nickel or copper added by electroplating.

Other variants of filling the gap may be envisaged.

The thickness of the filler material in the shown, preferred, embodiment is such that it exceeds the thickness of the replication material at the place of the spacer portions 24′. Therefore, the spacer portions of the tool cast from the sub-master protrude further than the portions at positions corresponding to the gap 29.

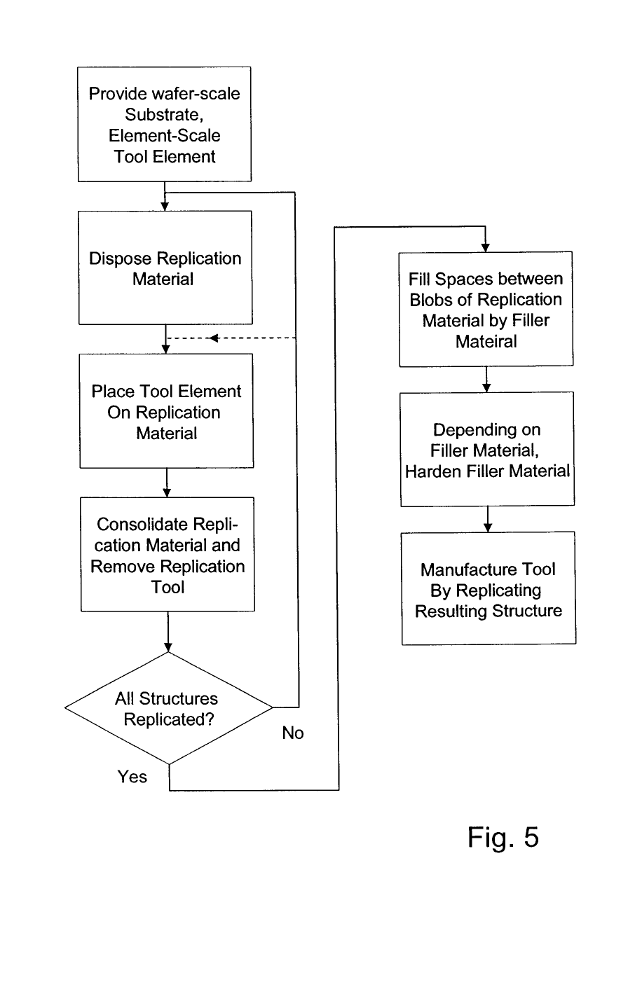

FIG. 5 shows a flowchart summarizing steps in a process according to the invention.

The gap (or space) between the regions covered by the replication material may be, but need not be, completely covered by the filler material 31. Rather, there may be regions to be kept free of replication material, for example in a peripheral region not used for replication or where after replication special measures are applied to the tool (such as adding a holder).

As a further variant, the tool element (for example master tool) does not necessarily comprise a structure corresponding to the negative copy of the surface of exactly one optical element. Rather, the tool element may encompass the (negative) structures of a few optical elements, for example of groups of four or six or nine optical elements.

Various other embodiments may be envisaged without departing from the scope and spirit of the invention.

1. In a process of manufacturing, by replication, a plurality of optical elements each having geometrical surface features, a method of manufacturing an element that includes a plurality of replicated structures, the method comprising the steps of
providing an element substrate,
replicating, by embossing, a surface of a tool element, which surface comprises a negative copy of the geometrical surface feature, into replication material disposed at a first place on a surface of the element substrate,
subsequently hardening the replication material,
replicating said surface of the tool element into replication material disposed at a second place on said element substrate,
subsequently hardening said replication material, and
the method comprising the further step of
subsequently filling a gap between replication material disposed at the first place and replication material disposed at the second place by filler material.

2. The method according to claim 1, wherein the gap between regions of material with replicated structures is filled to an extent that the thickness of the filler material is greater than a minimal thickness of material in the regions of replicated material.

3. The method according to claim 2, wherein a master tool has a replicating surface which comprises flat sections where the height of the replicating surface is at a maximum, so that said flat sections define a region where the minimal thickness of the material with replicated structures is attained.

4. The method according claim 1, wherein the filler material is a curable plastic material.

5. The method according to claim 4, wherein the filler material is a material of the same composition as the replication material.

6. The method according to claim 1, wherein the element substrate comprises an electrically conductive surface portion and wherein the filler material is applied galvanically.

7. The method according to claim 1, wherein the element substrate has the size and shape of an optical wafer.

8. The method according to claim 1, wherein said surface of the tool element is, in consecutive sub-steps replicated into replication material disposed at at least 40 places on said substrate and wherein gaps between replication material disposed at different places are filled by the filler material in a single step.

9. A process of manufacturing a plurality of optical elements each having surface features, the process comprising the steps of providing a master or a master tool and carrying out at least a first and a second replication operation to provide a final replica comprising surface portions being a positive or negative copy of a surface portion of the master or master tool, the first replication operation comprising a method of manufacturing an element including the steps of
providing an element substrate,
replicating, by embossing, a surface of a tool element, which surface comprises a negative copy of a geometrical surface feature, into first replication material disposed at a first place on a surface of the element substrate,
subsequently hardening the replication material,
replicating said surface of the tool element into first replication material disposed at a second place on said substrate,
hardening said first replication material,
subsequently filling a gap between first replication material disposed at the first place and first replication material disposed at the second place by filler material,
the second replication operation including the step of providing a substrate, and a second replication material disposed between the substrate and said element, of moving the substrate and said element against each other, and of hardening the second replication material.

10. The method of claim 1, wherein within the step of filling the gap between replication material disposed at the first place and replication material disposed at the second place, the replicated surfaces of the tool element within the replication materials are kept free from filler material.

11. The method of claim 9, wherein within the step of filling the gap between replication material disposed at the first place and replication material disposed at the second place, the replicated surfaces of the tool element within the replication materials are kept free from filler material.

12. The method of claim 1, further including the step of replicating the element that comprises the plurality of replicated structures.

13. A process of manufacturing, by replication, a plurality of optical elements each having geometrical surface features, the process comprising a method of manufacturing an element that includes a plurality of replicated structures, the method comprising the steps of:
providing an element substrate,
replicating, by embossing, a surface of a tool element, which surface comprises a negative copy of the geometrical surface feature, into replication material disposed between the tool and a first place on a surface of the element substrate to yield a first replicated surface,
subsequently hardening the replication material,
replicating said surface of the tool element into replication material disposed disposed between the tool and a second place on said substrate to yield a second replicated surface,
subsequently hardening said replication material,
the method comprising the further steps of:
subsequently applying a filler material selectively to a gap between replication material disposed at the first place and replication material disposed at the second place but not to the first and second replicated surfaces;
wherein the process further comprises the step of replicating the element that comprises the plurality of replicated structures.
